(19) United States
(12) Patent Application Publication
(10) Pub. No.: US 2024/0416308 A1
(43) Pub. Date: Dec. 19, 2024

(54) Device Comprising a Reaction Container for Solids Reactions

(71) Applicant: H. C. Starck Tungsten GmbH, Goslar (DE)

(72) Inventors: Tino Saeuberlich, Bad Harzburg (DE); Jürgen Exner, Liebenburg (DE); Knut Warnecke, Goslar (DE); Harald Oelmann, Langelsheim (DE); Juliane Meese-Marktscheffel, Goslar (DE)

(21) Appl. No.: 18/695,886

(22) PCT Filed: Oct. 13, 2022
(86) PCT No.: PCT/EP2022/078514

§ 371 Date: Mar. 27, 2024

(30) Foreign Application Priority Data
Oct. 14, 2021 (EP) 21202578.7

(51) Int. Cl. B01J 8/04; B01J 8/00; C22B 5/12

(52) U.S. Cl. CPC B01J 8/048; B01J 8/006; C22B 5/12

(57) ABSTRACT

The present invention relates to a device comprising at least one reaction container for receiving pulverulent reaction products, the reaction container having a frame and a screen fabric which is detachably connected to the frame. The invention also relates to the use thereof in gas/solids reactions.

The present invention relates to a device having at least one reaction container for receiving powdery reactants, said reaction container having a frame and a mesh fabric detachably connected with the frame, and to the use thereof in gas/solid state reactions.

The significance of metals for humanity can be seen, inter alia, from the fact that whole phases of the development of humanity are designated after the materials employed as the Bronze Age and the Iron Age. However, exceedingly few metals occur in their pure form in nature, so that the production of metals and their selected compounds further play a key role. Metals and their compounds, such as their carbides, are usually obtained by reducing the corresponding oxides using a solid state reaction. Solid state reactions are chemical reactions in which at least one reactant is in a solid state of matter. The production of metals is usually effected by reducing the corresponding oxides with a reducing agent, such as hydrogen, i.e., in a gas/solid state reaction in which the gaseous reducing agent flows through the powdery solid. Thus, the outcome of the reaction depends on, on the one hand, how effectively the powder employed is contacted with the gas and, on the other hand, how fast the removal of the by-products formed during the reaction can be done.

Gas/solid state reactions are characterized in that a solid, mostly a powder, is contacted with a gaseous reactant. The transport of the gas through the powdery solid can be effected either by diffusion, i.e., based on a concentration gradient, and/or by convective processes based on a pressure gradient. Therefore, solid state reactions are usually performed in a so-called boat, into which the solid is placed as a powder bed, which is then exposed to a gas flow. However, these conventional boats have the disadvantage that the removal of the gaseous reaction products by diffusion processes can occur only upwards, i.e., against gravity. The insufficient removal of these gas components then usually has a negative effect on the progress of the reaction.

DE 2126843 describes a method for preparing metal carbides in which boats provided with a gas-permeable bottom are used.

GB 672,423 relates to a continuous method for the preparation of metal powders, in which the material is spread on a sieve-like surface so arranged that the material is exposed on all sides to the reducing atmosphere.

DE 2 120 598 discloses a method for reducing powdery metal oxides supported in layers on perforated trays, in which the boats are conveyed downwards in a vertical direction, and a reducing gas flow flows through them upwards in the opposite direction.

Although the use of boats with a gas-permeable bottom has been known in the prior art, there is a continuous need for improved methods for preparing metal powders. In addition, it is desirable to achieve an increased flexibility within the scope of the usual reactions.

In this context, the present invention provides a device comprising at least one reaction container, in which a mesh fabric can be replaced in a simple way. Thus, for example, powders having different particle sizes can be employed, or the removal of the gaseous reaction products can be controlled.

Therefore, the present invention firstly relates to a device having at least one reaction container for receiving powdery reactants, said reaction container having a frame and a mesh fabric detachably connected with the frame, wherein said reaction container further has a support construction for supporting said mesh fabric.

The device according to the invention offers the advantage that the removal of the gaseous components formed during the reaction is effected not only by diffusion processes, but also by convective material transport processes caused by gravity, which enables an additional mechanism of material transport, whereby, among other things, the reaction time can be shortened significantly, and thus the throughput can be increased. The detachable connection between the frame and mesh fabric enables the mesh fabric to be replaced in a simple manner, so that it can be adapted in a simple manner, for example, to different grain sizes of the powders employed.

The device according to the invention is further characterized by the size of the reaction container, which has such a design that industrial-scale reactions are also possible. In a preferred embodiment, said reaction container has a width of at least 3 cm, preferably at least 10 cm, more preferably at least 15 cm. The length of the reaction container is preferably at least 8 cm, preferably at least 25 cm, more preferably at least 40 cm. These dimensions enable such devices to be used beyond their use in laboratories or smaller pilot plants.

In a preferred embodiment, in order to ensure the stability of the powder bed in the reaction container, the latter may be provided with detachably connected side parts. For example, this allows for a larger amount of powder to be reacted. The height of the side parts is preferably adapted to the height of the powder bed. Preferably, the top edge of the side parts is at least 1 mm above the top edge of the powder bed. In this way, in reactions involving an increase in volume of the powder, an overflow of the reaction container can be prevented, without adversely affecting the rate of the reaction. In order to convert economically relevant quantities of solid, powder beds having a height of at least 2 mm have proven useful, in particular. Therefore, an embodiment is preferred in which the height of the powder bed is at least 2 mm.

According to a preferred embodiment, the reaction container has a rectangular layout. This shape enables a simple charging and discharging of the device with the reaction container. For this purpose, the device and the reaction container preferably further have guide rails that are adapted to one another, and that are preferably provided on the longitudinal sides for the reaction container.

Within the scope of the present invention, it has been surprisingly found that a significantly larger amount of reactants could be employed as compared to conventional boats, without this adversely affecting the progress of the reaction or the quality of the product. Rather, a shortening of the reaction time could be observed. In order to ensure the stability of the device according to the invention for larger loadings, the mesh fabric on which the reactants are supported may be stabilized. Therefore, the reaction container has a support construction for supporting said mesh fabric. Preferably, the support construction has a design to not interfere with the removal of gas components formed during the reaction. For example, the support construction can be formed as a perforated metal sheet or grid, or from a porous material.

According to the present invention, the mesh fabric is detachably connected with the frame of the reaction container, and thus can be easily replaced. In particular, clamping means have proven useful for this. In a preferred embodiment, therefore, the mesh fabric is connected to the frame by means of a clamping means. Thus, preferably, a clamp with clamping bolts, by which the mesh fabric can be clamped into the frame, is preferably provided on at least one of the front sides of the reaction container.

The device according to the invention is further advantageous in that several reaction containers can be used simultaneously, whereby the reaction throughput can be enhanced significantly, which is of interest, in particular, in industrial scale productions. Therefore, an embodiment is preferred in which said device includes at least 2, preferably at least 3, reaction containers. Even though the number of reaction containers as such is not limited, too many reaction containers should not be employed, in order to ensure a homogeneous progress of the reaction. Accordingly, an embodiment is preferred in which said device includes not more than 10, preferably not more than 6, reaction containers. The reaction containers are advantageously arranged on top of one another. Therefore, an embodiment is preferred in which the reaction container can be stacked.

The device according to the invention allows for the mesh fabric to be easily replaced, so that it can be adapted to the respective reaction requirements. Thus, for example, the mesh size of the mesh fabric can be adapted accordingly. Preferably, the mesh size of the mesh fabric is within a range of from 25 μm to 5 mm, preferably from 40 μm to 5 mm.

The device according to the invention is employed in high temperature processes, in particular. Therefore, an embodiment is preferred in which the frame and/or the mesh fabric is made of an alloy based on iron, nickel or cobalt, which have proven useful, in particular, as materials suitable for high temperature processes within the scope of the present invention. Alternatively, ceramic materials can be employed.

The structure according to the invention provides the reaction container with a particular stability, so that it is suitable, in particular, for use in continuous methods, which allow for a continuous production as opposed to batch processes. Therefore, an embodiment is preferred in which the device according to the present invention is a continuously operated device, preferably a continuously operated furnace, especially a pushing furnace or rotary kiln.

In contrast to conventional reactions, in which the gas is usually passed through the powder bed from below with application of pressure when reaction containers with a gas-permeable bottom are used, the device according to the invention is preferably arranged in such a way that the gas flow is in parallel with the device according to the invention, i.e., in a longitudinal direction with respect to the reaction container. Among other things, this has the advantage that no powder is discharged from the container during the reaction. Further, it is prevented that a concentration gradient of the reacted powder decreasing from the bottom to the top is formed through the powder bed. Further, in this way, a homogeneous gas flow can be built that can dispense with a pressure-driven gradient.

The device according to the invention is provided, in particular, for gas/solid state reactions as employed in the production of metal powders or other powders. Therefore, the present invention further relates to the use of the device according to the invention for gas/solid state reactions, especially for reduction, carburization, oxidation, calcination and/or nitridation reactions.

The device according to the invention is suitable, in particular, for reactions in which gaseous components are formed as by-products or waste, enabling an effective removal thereof. Thus, for example, in usual reduction reactions with hydrogen as the reducing agent, water vapor as an oxidation product of hydrogen is obtained in addition to the reduced compound. However, the presence of water vapor has a negative effect on the progress of the reduction reaction, and may lead to a standstill thereof in the worst case. This is prevented by the device according to the invention, which allows for a fast removal of the water vapor formed. Therefore, reactions in which the device according to the invention can be used advantageously are those in which water vapor, CO₂, Ar, gaseous hydrocarbons, CO, Cl₂, NOₓ or SO₂ are formed or employed.

The present invention is further explained by means of the following Example, which should by no means be understood as limiting the idea of the invention.

### EXAMPLE

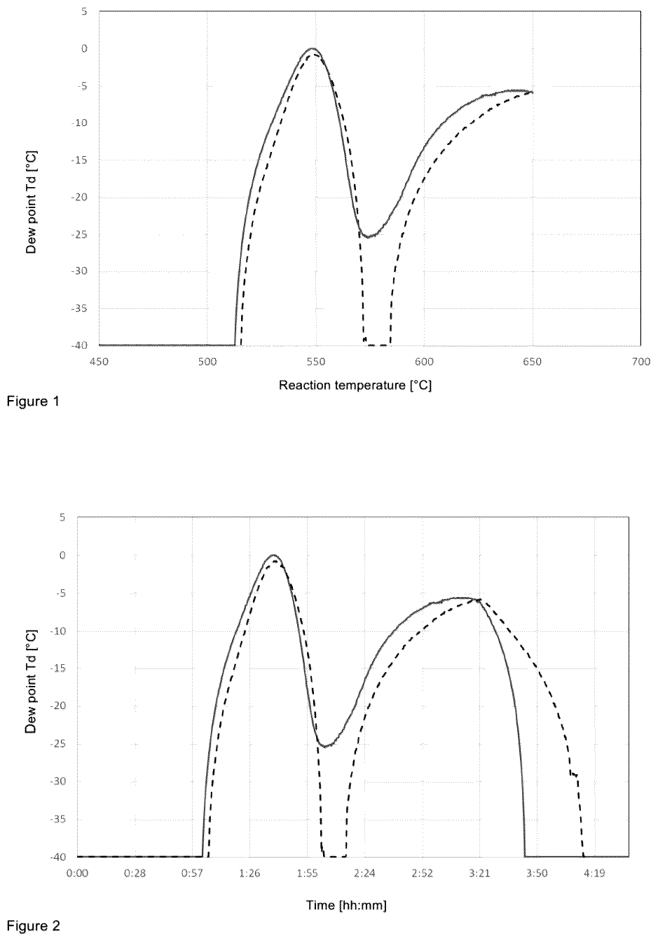

FIGS. 1 and 2 show the course of the reduction of tungsten oxide, in which FIG. 1 shows the reaction course up to 650° C., and FIG. 2 shows the complete time course of the reaction. Thus, tungsten oxide was heated at a constant heating rate in a rotary kiln under a constant hydrogen flow up to a temperature of 650° C., and then the temperature was kept constant. The dew point of the hydrogen was measured at the gas outlet, in which the dew point is a measure of the amount of water produced during the reduction. The dew point may be determined, for example, by using commercial measuring methods, such as a chilled mirror dew point hygrometer, capacitive probes, or laser measuring devices. As can be seen from the measuring curves, the reaction proceeds significantly more slowly and even comes to a halt when a conventional reaction container (boat, dashed line) is used. Also, the dew point of the leaving hydrogen has a significantly increased moisture content when a conventional boat is used as compared to the use of the device according to the invention (solid line). As FIG. 2 illustrates, the reaction proceeds significantly faster in the reaction container according to the invention (solid line).

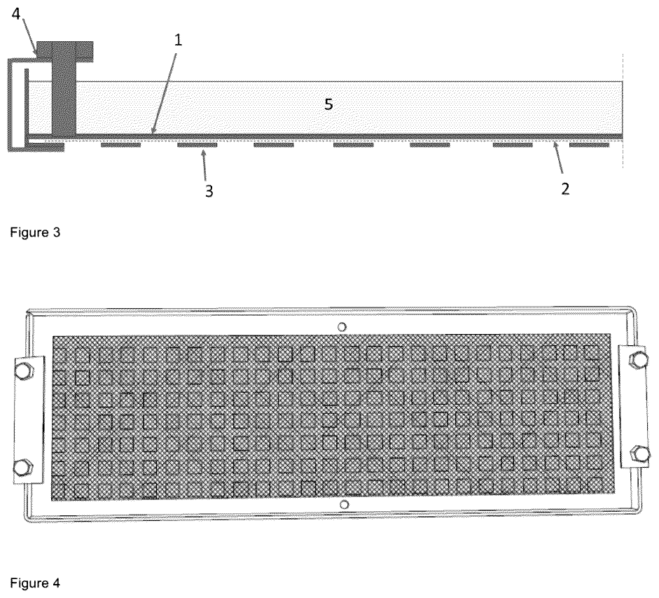

FIG. 3 shows a schematic cross-sectional view of the device according to the invention comprising a clamp frame (1) for clamping the mesh fabric (2), which is supported by the support construction (3). The clamp frame (1) can be fixed by a clamp (4) with clamp screws and thus together with the mesh fabric (2) forms the reaction container for receiving the powdery reactants (5).

FIG. 4 shows a schematic top view of the device according to the invention represented in FIG. 3.

1. A device having at least one reaction container for receiving powdery reactants, said reaction container having a frame and a mesh fabric detachably connected with the frame, characterized in that said reaction container further has a support construction for supporting said mesh fabric.

2. The device according to claim 1, characterized in that the mesh fabric is connected to the frame by means of a clamping means.

3. The device according to claim 1, characterized in that said reaction container has a width of at least 3 cm.

4. The device according to claim 1, characterized in that said reaction container has a length of at least 8 cm.

5. The device according to claim 1, characterized in that said reaction container has a rectangular shape.

6. The device according to claim 1, characterized in that said device includes at least 2 reaction containers.

7. The device according to claim 6, characterized in that said device includes not more than 10 reaction containers.

8. The device according to claim 6, characterized in that said reaction containers are arranged one on top of another.

9. The device according to claim 8, characterized in that the reaction container can be stacked.

10. The device according to claim 1, characterized in that said mesh fabric has a mesh size of from 25 μm to 5 mm.

11. The device according to claim 1, characterized in that said device is arranged in such a way that a gas flows in a longitudinal direction with respect to the reaction container.

12. The device according to claim 1, characterized in that the frame and/or the mesh fabric is made of an alloy based on iron, nickel or cobalt.

13. Use of the device according to claim 1 for gas/solid state reactions.

14. The device according to claim 3, characterized in that said reaction container has a width of at least 10 cm.

15. The device according to claim 14, characterized in that said reaction container has a width of at least 15 cm.

16. The device according to claim 4, characterized in that said reaction container has a length of at least 25 cm.

17. The device according to claim 16, characterized in that said reaction container has a length of at least 40 cm.

18. The device according to claim 6, characterized in that said device includes at least 3 reaction containers.

19. The device according to claim 7, characterized in that said device includes not more than 6 reaction containers.

20. The device according to claim 10, characterized in that said mesh fabric has a mesh size of from 40 μm to 5 mm.
